(19) United States
(12) Patent Application Publication
(10) Pub. No.: US 2012/0133985 A1
(43) Pub. Date: May 31, 2012

(54) IMAGE FORMING APPARATUS, INFORMATION PROCESSING APPARATUS, AND IMAGE FORMING SYSTEM

(76) Inventors: Yasuhiko KIDA, Osaka (JP); Hideaki SHIMIZU, Osaka (JP)

(21) Appl. No.: 13/293,533

(22) Filed: Nov. 10, 2011

(30) Foreign Application Priority Data
Nov. 30, 2010 (JP) P2010-267361

(51) Int. Cl. G06K 15/02

(52) U.S. Cl. 358/1.16

(57) ABSTRACT

An image forming apparatus includes an operation unit receiving image formation instruction, an image formation unit forming an image, and a control unit which makes the image formation unit form an image when the operation unit receives the image formation instruction. The image forming apparatus includes a data acquisition unit acquiring an image formation object data, a data transformation unit transforming the image formation object data into a final print format data, and a memory unit storing the final print format data. The control unit makes the data transformation unit transform the image formation object data into the final print format data and makes the memory unit store the final print format data when the data acquisition unit acquires the image formation object data. The control unit makes the image formation unit form an image based on the final print format data.

### CROSS REFERENCE TO RELATED APPLICATIONS

Priority is claimed on Japanese Unexamined Patent Application, First Publication No. 2010-267361, filed Nov. 30, 2010, the contents of which are incorporated herein by reference.

### BACKGROUND OF THE INVENTION

1. Field of the Invention

The present invention relates to an image informing apparatus, an image information apparatus and an image forming system.

2. Description of the Related Art

In recently years, information data consisting of images or words are delivered via a communication network such as internet. A display apparatus indicates information based on the delivered information. Unlike TVs or new papers, the display apparatus not only can indicate the information delivered but also switch the information according to the setting location of a display apparatus or time zones. Thereby, the display apparatus can effectively indicate information to specific target people. Furthermore, the display apparatus can easily switch information to be indicated by updating information data stored in a delivery source (delivery server). Therefore, time is not required to switch displayed information.

As a method of information output without using the display apparatus that indicates information, there is a printing method that makes an image forming apparatus such as a multifunctional apparatus print information on a sheet. For example, stores such as convenience stores provide an information processing apparatus with an image forming apparatus. The information processing apparatus stores information data delivered from delivery servers. Furthermore, when the image forming apparatus receives an output instruction, the image forming apparatus forms the information on a sheet based on the information data acquired from the information processing apparatus.

For the related art described above, the information data (image formation object data) delivered from the delivery server to the information processing apparatus corresponds to a PDF format or JPEG format. For example, when the information processing apparatus receives an information data, the information processing apparatus transforms the information data into a PDL (Page Description Language) format data, and transmits the PDL format data to the image forming apparatus. In this manner, as the information processing apparatus performs a data transformation process after receiving an output instruction, it consumes time until the image forming apparatus transmits the information data after receiving the information from the information processing apparatus. Furthermore, the image forming apparatus takes time to complete image formation (e.g., one minute for A4 size paper) because the image forming apparatus has to transform a PDL format data input from the information processing apparatus into a bit map image data as final print format data. As is described above, as time consume the usual image forming apparatus to finish forming images after receiving an output instruction, users need to await for a while.

The present invention takes into consideration the issues described above. For example, one of the objects of the present invention is to reduce time of image formation of the image forming apparatus.

### SUMMARY OF THE INVENTION

To achieve objects described above, the present invention employs the followings.

With respect to an embodiment of the present invention, an image forming apparatus is configured to include an operation unit configured to receive image forming instruction, an image formation unit configured to form an image, a control unit configured to make the image forming unit form the image when the operation unit receives the image forming instruction, a data acquisition unit configured to acquire data, a data transformation unit configured to transform the data into final print format data, and a memory unit configured to store the final print format data, wherein when the data acquisition unit acquires the image formation object data, the control unit makes the data transformation unit transform the image formation object data into the final print format data and makes the memory unit store the final print format data, and when the operation unit receives the image forming instruction, the control unit makes the image formation unit form the image based on the final print format data stored in the memory unit.

Furthermore, with respect to an embodiment of the present invention, an information processing apparatus includes a communication unit configured to communicate with an image forming apparatus, a data acquisition unit configured to acquire an image formation object data, a data transformation unit configured to transform the image formation object data into a final print format data, and a control unit configured to make the data transformation unit transform the image formation object data into a final print format data and make the communication unit transmit the final print format data to the image forming apparatus when the data acquisition unit acquires the image formation object data.

With respect to an embodiment of the present invention, an image formation system includes an information processing apparatus, and an image forming apparatus configured to communicate with the information processing apparatus, wherein when the information processing apparatus receives an image formation object data, the information processing apparatus transforms the image formation object data into a final print format data and transmits the final print format data to the image forming apparatus, wherein when the image forming apparatus receives the image formation object data from the information processing apparatus, the image forming apparatus stores the final print format data, and when the image forming apparatus receives image formation instruction, the image forming apparatus forms an image based on the final print format data.

### BRIEF DESCRIPTION OF THE DRAWINGS

Referring now to the attached drawings which form a part of this original disclosure:

FIG. 1 is a drawing that illustrates a system configuration of an image formation system S in accordance with an embodiment of the present invention;

FIG. 2 is a drawing that illustrates a block diagram of functions of a multifunctional apparatus A and an information processing apparatus C of the image formation system S in accordance with an embodiment of the present invention; and

FIG. 3 is a drawing that illustrates a sequence diagram of the multifunctional apparatus A and the information processing apparatus C of the image formation system S in accordance with an embodiment of the present invention.

### DETAILED DESCRIPTION OF THE INVENTION

With reference to the figures, a description will be given below for an embodiment in accordance with the preset invention.

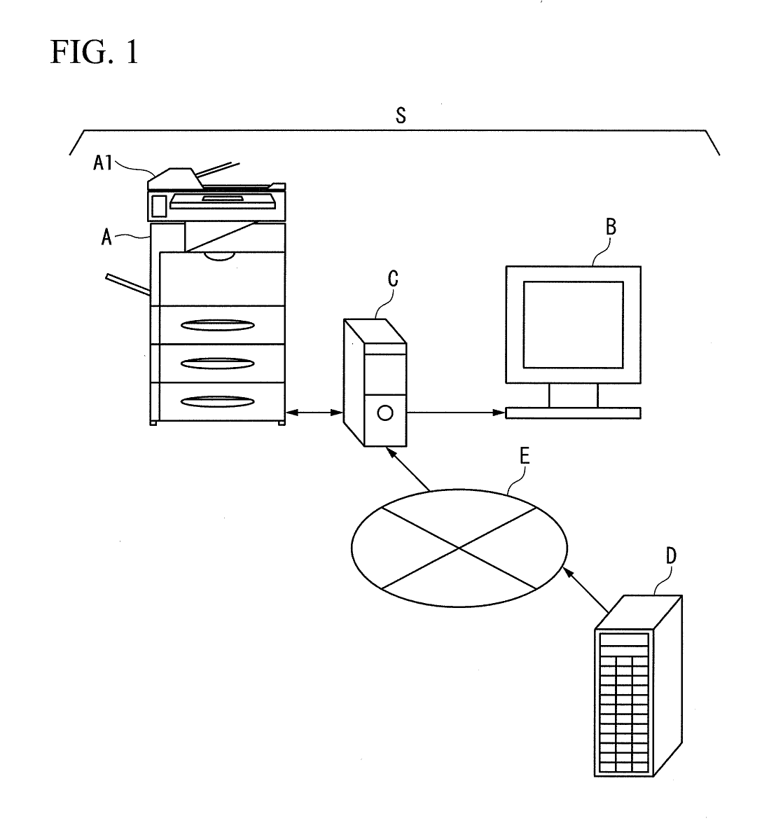

As shown in FIG. 1, an image forming system S in accordance with the present embodiment includes a multifunctional apparatus (image forming apparatus) A, a display apparatus B, an information processing apparatus C, a delivery server D, and a communication network E.

The multifunctional apparatus A includes functions of copying, printing, scanning, and transmitting/receiving of facsimiles. The multifunctional apparatus A is communicatively connected to the information processing apparatus C, and forms images based on data input from the information processing apparatus C.

The display apparatus B may be a liquid crystal display (LCD). The display apparatus is communicatively connected to the information processing apparatus C, and indicates information based on an information data input from the information processing apparatus C.

The information processing apparatus C is, for example, a computer, which is connected to the multifunctional apparatus A and the display apparatus B. The information processing apparatus C is communicatively connected to the delivery server D via the communication network E. The information processing apparatus C stores information data (image formation object data) distributed from the delivery server D, transforms the information data into PDL format data (intermediate print format data) and transmits the PDL format data to the multifunctional apparatus A. The information processing apparatus C makes the multifunctional apparatus A form images based on the distributed information data. Furthermore, the information processing apparatus C makes the display apparatus B indicate information based on the information data.

The delivery server D is a server which is provided for a purpose of distribution of information data (image formation object data) such as PDF format data and JPEG format data. The delivery server D is communicatively connected to the information processing apparatus C and other information processing apparatuses (not indicated in the figure) via the communication network E. For the delivery server D, the information data is updated at all times, and the delivery server D distributes the updated information to the information processing apparatus C and other information processing apparatuses.

The communication network E includes a local area network and public internet network. The communication network E connects between the information processing apparatus C and the delivery server D. The communication network E is signal transmission lines used for communication between the information processing apparatus C and the delivery server D.

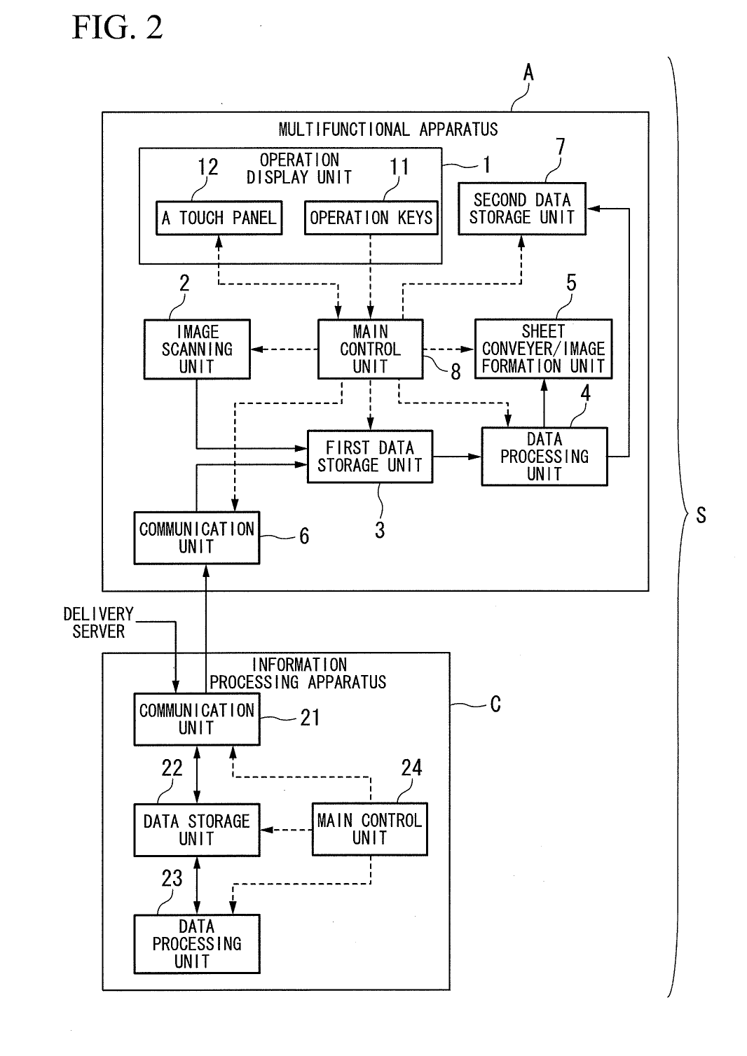

Furthermore, a description will be given of the multifunctional apparatus A and its functional configurations with reference to FIG. 2.

The multifunctional apparatus A includes an operation display unit (operation unit) 1, an image scanning unit 2, a first data storage unit 3, a data processing unit (data transformation unit) 4, a sheet conveyer/image formation unit (image formation unit) 5, a communication unit (data acquisition unit) 6, a second data storage unit (storage unit) 7, and a main control unit (control unit) 8, as shown in FIG. 2.

The operation display unit 1 includes operation keys 11, a touch panel 12. The operation display unit 1 functions as an interface associating a user with the multifunctional apparatus A. When an operation key 11 is pressed down, the operation display unit 1 receives instruction which corresponds to the pressed operation key 11. Furthermore, the operation key 11 receives operation instruction corresponding to the operation button indicated on the touch panel 12. The operation display unit 1 transmits the operation instruction to the main control unit 8, and indicates a variety of screens on the touch panel 12 in response to the instruction signal of the main control unit 8.

The image scanning unit 2 reads a manuscript or an image of an manuscript (manuscript image) set on a platen glass using line sensors, transforms the manuscript image into a manuscript image data. Furthermore, the image scanning unit 2 transforms the manuscript image data (image format object data) into PDL format data, and transmits the PDL format data to a first data storage unit 3. The manuscript set on the platen glass is automatically fed by the automatic sheet feeder apparatus A1 (not indicated in the figure) based on the control signal input from the main control unit 8.

The first data storage unit 3 is, for example, a semiconductor memory or a hard drive device. The first data storage unit 3 stores a intermediate print format data such as PDL (Page Description Language) format data input from the intermediate print format data or the information processing unit C based on the control signal input from the main control unit 8. The first data storage unit 3 reads and transmits these data to the data processing unit 4.

The data processing unit 4 performs each image processing (e.g., image processing corresponding to enlarged-reduced copy) for the intermediate print format data input from the first data storage unit 3 based on the control signal input from the main control unit 8. The data processing unit 4 transforms the intermediate print format data into a bit map image data of a final print format. In other words, the data processing unit 4 transforms an RGB image data (color image data) corresponding to the three primary colors of light into a YMCK image data which is based on reference colors, such as Y (yellow), M (magenta), C (cyan), and K (black). The data processing unit 4 transmits the YMCK image data to the sheet feeder/image formation unit 5. Furthermore, the data processing unit 4 transforms a PDL format data input from the first data storage unit 3 into a final print format data, which is an image formation format such as the bit map image data or the like based on the control signal input from the main control unit 8. The data processing unit 4 transmits the transformed bid map image data to the second data storage unit 7.

The sheet feeder/image formation unit 5 includes a print engine (photo sensitive drum, charging device, developing apparatus and fixing roller), and sheet feed roller and sheet ejection roller. The sheet feeder/image formation unit 5 conveys a recoding paper from a paper storage cassette (not indicated in the figure) based on the control signal of the main control unit 8. The sheet feeder/image formation unit 5 forms images based on the bit map image data input from the data processing unit 4 or the second data storage unit 7, and ejects the recording paper to a paper ejection tray (not indicated in the figure).

The communication unit 6 is connected to the information processing unit C via communication cables. The communication unit 6 performs data communication with the information processing unit C based on the control signal of the main control unit 8.

The second data storage unit 7 is, for example, a semiconductor memory or a hard disk drive device. The second data storage unit 7 stores the bit map image data of the image formation format input from the data processing unit 4. The second data storage unit 7 reads the bit map image data and transmits the bit map image data to the sheet feeder/image formation unit 5.

The main control unit 8 includes a CPU (Central Processing Unit), a ROM (Read Only Memory), a RAM (Random Access Memory). Furthermore, the main control unit 8 is connected to the operation display unit 1, the image scanning unit 2, the first data storage unit 3, the data processing unit 4, the sheet feeder/image formation unit 5, and an interface circuit which performs signal input/output with the communication unit 6 and the second data storage unit 7. The main control unit 8 controls the whole operations of the multifunctional apparatus A based on the operation instruction input from a control program stored in the ROM and the operation display unit 1. Furthermore, the control program stored in the ROM includes a bit map image data control program. The main control unit 8 controls a data transformation processing of the bit map image data based on the bit map image data control program.

Next, a description will be given of the functional configurations of the information processing apparatus C with reference to FIG. 2.

As shown in FIG. 2, the information processing unit C includes a communication unit (data reception unit and communication unit) 21, a data storage (memory unit) 22, a data processing unit (data transformation unit) 23 and a main control unit (control unit) 24.

The communication unit 21 is connected to the multifunctional apparatus A via the communication cables. The communication unit 21 is connected to the delivery server D via the communication network E, and performs communication with the multifunction apparatus A and the delivery server D based on a control signal of the main control unit 24.

The data storage unit 22 is, for example, a semiconductor memory or a hard disk drive device. The data storage unit 22 stores information data acquired by the communication unit 21 from the delivery server D. The data storage unit 22 reads out the information data and transmits the information data to the data processing unit 23. Furthermore, the data storage unit 22 stores PDL format data generated in the data processing unit 23. The data storage unit 22 reads out the PDL format data and transmits the PDL format to the communication unit 21.

The data processing unit 23 transforms information data input from the data storage unit 22 into PDL format data based on the control signal input from the main control unit 24, and transmits the PDL format data to the data storage unit 22.

The main control unit 24 includes a CPU (Central Processing Unit), a ROM (Read Only Memory), a RAM (Random Access Memory). The main control unit 24 is connected to an interface circuit or the like which performs signal input/output with the communication unit 21, the date storage unit 22 and the data processing unit 23. The main control unit 24 controls the whole operations of the information processing apparatus C based on a control program stored in the ROM. In this case, the control program stored in the ROM includes a PDL format data control program. The main control unit 24 controls the PDL format data transformation processing based on the PDL format data control program.

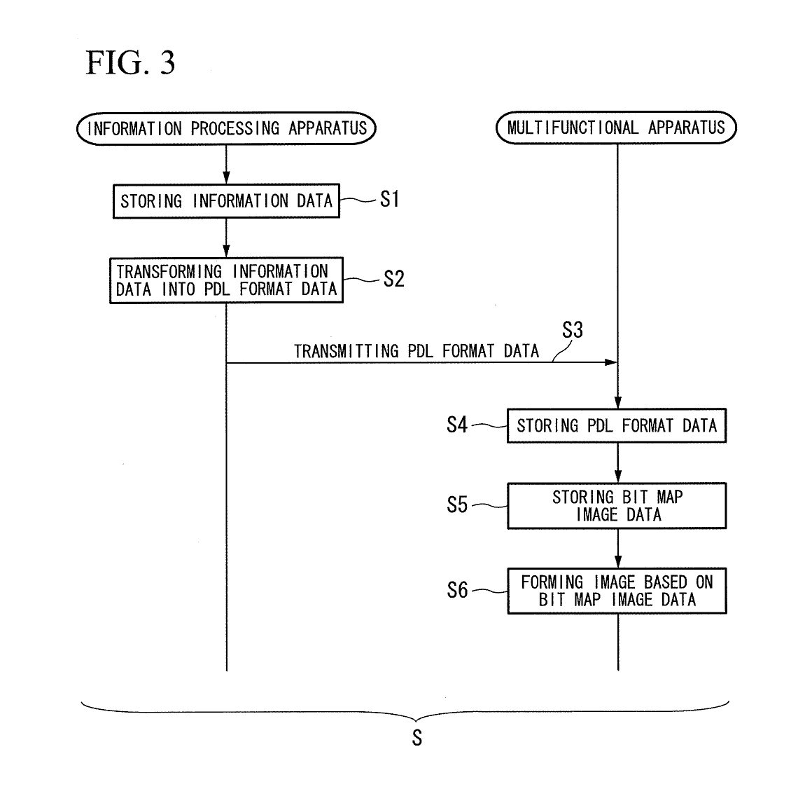

Furthermore, a description will be given of the operations of the multifunctional apparatus A and the information processing apparatus C in the image formation system S with reference to FIG. 3.

In the information processing apparatus C, when the communication unit 21 receives an information data (image format object data) from the delivery server D, the main control unit 24 makes the data storage unit 22 store the information data (step S1). After step S1, the main control unit 24 makes the data processing unit 23 transform the information data into a PDL format data (intermediate print format data) and stores the PDL format into the data storage unit 22 (step S2). After step S2, the main control unit 24 makes the communication unit 21 transmit the PDL format data to the multifunctional apparatus A (step S3).

For the multifunctional apparatus A, when the communication unit 6 receives the PDL format data from the information apparatus C, the main control unit 8 makes the first data storage unit 3 store the PDL format data (step S4).

After step S4, the main control unit 8 makes the data processing unit 4 transform the PDL format data into a bit map image data which is an image formation format, and makes the second data storage unit 7 store the bit map image data (step S5). Furthermore, after step S5, when the operation display unit 1 receives an instruction (image formation instruction), the main control unit 8 makes the sheet conveyer/image formation unit 5 form an image of information on a recording sheet based on the bit map image data that is previously stored in the second data storage unit 7 (step S6). Then, the image formation is finished (END). Furthermore, when the operation display unit 1 receives an additional information output instruction, the main control unit 8 makes the sheet conveyer/image formation unit 5 form a normal copying image on the front surface of an recording sheet. In this case, the main control unit 8 makes the sheet conveyer/image formation unit 5 form image of information on the back surface of the recording sheet.

As described above, in the image formation system S, an image formation object data is previously acquired from the delivery server D before an image formation instruction is received, and the image formation object data is transformed into a PDL format data. In addition, the PDL format data is transformed into a bit map image data of an image formation format and then the bit map image data is stored into the multifunctional apparatus A. In this manner, when an image formation is performed, as the data of the final print format previously transformed is used, the time of transforming an information data can be saved. Therefore, in total, the time of image formation can be reduced.

Up to now, although the descriptions have been given as an embodiment in accordance with the present invention, the present invention is not limited to the above embodiment. For example, variations can be considered as described below.

In the above embodiment, the multifunctional apparatus A transforms a PDL format data into a bit map image data and stores the bit map image data. The present invention is not limited to the above embodiment.

The multifunctional apparatus A may store the PDL format data previously acquired from the information processing apparatus C without transforming the PDL format data, and the multifunctional apparatus A may transform the acquired PDL format data into a bit map image data after receiving an output instruction.

In the present embodiment, the information processing apparatus C transforms an information data into a PDL format data, and the multifunctional apparatus A transforms the PDL format data into a bit map image data. Alternatively, the multifunctional apparatus A may include the information processing apparatus C, and acquire an information data from the delivery server D. Then the multifunctional apparatus A may transform the information data into a bit map image data, and store the bit map image data. When the multifunctional apparatus A receives an output instruction, the multifunctional apparatus may form an image based on the bit map image data.

Furthermore, the multifunctional apparatus A may acquire an information data from the delivery server D, transform the information data into a PDL format data, and keep storing the PDL format. And the multifunctional apparatus A may transform the PDL format data into a bit map image data when receiving an output instruction. Furthermore, when the information processing apparatus C receives an information data from the delivery server D, the information processing apparatus C may transform the information data into a bit map image data, and transmit the bit map image data to the multifunctional apparatus A.

In addition, in the multifunctional apparatus A, before the PDL format data is transformed to a bit map image data, the main control unit 8 may estimate a volume of the bit map image data to be obtained after transforming the PDL format data. When the estimated volume is greater than a predetermined value of the bit map image data, the main control unit 8 may store the PDL format data into the first data storage unit 3 without transforming the PDL format data. When the main control unit 8 receives the output instruction, the main control unit 8 may transform the PDL format data into a bit map image data. As a bit map image data is greater than a PDL format data, the procedure described above can prevent the storage unit from overload.

In the above embodiment, an information data is acquired from the delivery server D, the present invention is not limited to the embodiment. For example, the information data may be acquired from an external memory such as a USB memory.

In view of the above description, it will be apparent to those skilled in the art from this disclosure that there exists a need for an improved apparatus and/or method. This invention addresses this need in the art as well as other needs, which will become apparent to those skilled in the art from this disclosure.

The term “configured” is used to describe a component, section or part of a device includes hardware and/or software that is constructed and/or programmed to carry out the desired function.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An image forming apparatus, comprising:
an operation unit configured to receive image forming instruction;
an image formation unit configured to form an image;
a control unit configured to make the image formation unit form the image when the operation unit receives the image forming instruction;
a data acquisition unit configured to acquire data;
a data transformation unit configured to transform a format of the data; and
a memory unit configured to store final print format data,
wherein when the data acquisition unit acquires image formation object data, the control unit makes the data transformation unit transform the image formation object data into the final print format data and makes the memory unit store the final print format data, and
when the operation unit receives the image forming instruction, the control unit makes the image formation unit form the image based on the final print format data stored in the memory unit.

2. The image forming apparatus according to claim 1,
wherein when the data acquisition unit acquires the image formation object data, the control unit makes the data transformation unit transform the image formation object data into a intermediate print format data and makes the memory unit store the intermediate print format data, and
when the operation unit receives the image forming instruction, the control unit makes the data transformation unit transfer the intermediate print format data into the final print format data of an image formation format and makes the image formation unit form the image based on the final print format data.

3. The image forming apparatus according to claim 1,
wherein when the data acquisition unit acquires the intermediate print format data, the control unit makes the data transformation unit transform the intermediate print format data into the final print format data and makes the memory unit store the final print format data, and
when the operation unit receives the image forming instruction, the control unit makes the image formation unit form the image based on the final print format data of the image formation format stored in the memory unit.

4. The image forming apparatus according to claim 3,
wherein when the data acquisition unit acquires the intermediate print format data, the control unit calculates an amount of the intermediate print format data before making the data transformation unit transform the intermediate print format data into the final print format data of the image formation format,
when the amount of the middle print format is more than a predetermined amount, the data transformation unit does not transform the intermediate print format data into the final print format data, and
when the operation unit receives an image formation instruction, the control unit makes the data transformation unit transform the intermediate print format data into the final print format data of the image formation format, and makes the image formation unit form the image.

5. An information processing apparatus, comprising:
a communication unit configured to communicate with an image forming apparatus;
a data acquisition unit configured to acquire data;
a data transformation unit configured to transform a format of the data; and
a memory unit configured to store the data;
a control unit configured to make the data transformation unit transform image formation object data into final print format data and make the communication unit transmit the final print format data to the image forming apparatus before the data acquisition unit acquires the data and the image forming apparatus receives an image formation instruction.

6. The information processing apparatus according to claim 5,
wherein before the data acquisition unit acquires the image formation object data and the image forming apparatus receives the image formation instruction, the control unit makes the data transformation unit transform the image formation object data into a intermediate print format data and makes the communication unit transmit the intermediate print format data to the image forming apparatus.

7. The information processing apparatus according to claim 5, further comprising:
a memory unit configured to store the final print format data,
wherein before the data acquisition unit acquires the image formation object data and the image formation apparatus receives the image formation instruction, the control unit makes the data transformation unit transform the image formation object data into a intermediate print format data, makes the memory unit store the intermediate print format data, makes the data transformation unit transform the intermediate print format data into a final print format data of an image formation format, and makes the communication unit transmit the final print format data to the image forming apparatus.

8. An image formation system, comprising:
an information processing apparatus; and
an image forming apparatus configured to communicate with the information processing apparatus,
wherein when the information processing apparatus receives image formation object data, the information processing apparatus transforms the image formation object data into final print format data and transmits the final print format data to the image forming apparatus,
when the image forming apparatus receives the image formation object data from the information processing apparatus, the image forming apparatus stores the final print format data, and
when the image forming apparatus receives image formation instruction, the image forming apparatus forms an image based on the final print format data.

9. The image formation system according to claim 8,
wherein when the information processing apparatus receives the image formation object data, the information processing apparatus transforms the image formation object data into intermediate print format data and transmits the intermediate print format data to the image formation apparatus,
when the image forming apparatus receives the intermediate print format data from the information processing apparatus, the image forming apparatus stores the intermediate print format data,
when the image forming apparatus receives the image formation instruction, the image forming apparatus transforms the intermediate print format data into the final print format data of an image formation format and forms an image based on the final print format data.

10. The image formation system according to claim 7,
wherein when the information processing apparatus receives the image formation object data, the information processing apparatus transforms the image formation object data into intermediate print format data and transmits the intermediate print format data to the image forming apparatus,
when the image forming apparatus receives the intermediate print format data from the information processing apparatus, the image forming apparatus transforms the intermediate print format data into the final print format data and stores the final print format data, and
when the image forming apparatus receives the image formation instruction, the image forming apparatus forms an image based on the final print format data.
